(19) United States
(12) Patent Application Publication
(10) Pub. No.: US 2023/0030903 A1
(43) Pub. Date: Feb. 2, 2023

(54) ENGINEERED WOOD PANEL WITH CONNECTIVITY LAYER

(71) Applicant: LOUISIANA-PACIFIC CORPORATION, NASHVILLE, TN (US)

(72) Inventors: JESSE SCHMITZ, NASHVILLE, TN (US); JARROD KEVIN LINE, BRENTWOOD, TN (US); LOUIS ESCOBEDO, NASHVILLE, TN (US); QINING SUN, NASHVILLE, TN (US)

(21) Appl. No.: 17/879,714

(22) Filed: Aug. 2, 2022

Related U.S. Application Data
(60) Provisional application No. 63/228,213, filed on Aug. 2, 2021.
(60) Provisional application No. 63/394,108, filed on Aug. 1, 2022.

(51) Int. Cl. E04C 2/28; E04C 2/52; B32B 21/02; B32B 15/10; B32B 15/20; B32B 3/30

(52) U.S. Cl. CPC E04C 2/28; E04C 2/526; B32B 21/02; B32B 15/10; B32B 15/20; B32B 3/30; E04C 2/46

(57) ABSTRACT

An engineered wood product with at least one engineered-wood substrate or core layer (such as, but not limited to, OSB), with a connectivity layer configured to reflect RF signals (e.g., wifi and/or cellular signals), thereby enhancing connectivity in adjacent or proximate spaces or areas. The connectivity layer may be a metallic material, such as, but not limited to, aluminum or copper. The layer may be a sheet or film or foil of the metallic material applied to the surface(s), or integrated into the interior, of the substrate or core layer. The layer also may be a coating or deposited layer. A connectivity layer may be “sandwiched” between two or more engineered-wood substrates, thereby forming a composite panel or product. The surface of the connectivity layer may be embossed or patterned.

This application claims benefit of and priority to U.S. Prov. App. No. 63/228,213, filed Aug. 2, 2021, and U.S. Prov. App. No. 63/394,108, filed Aug. 1, 2022, both of which are incorporated herein in their entireties by specific reference for all purposes.

### FIELD OF INVENTION

This invention relates to an engineered wood (e.g., OSB) panel manufactured with an integrated metallic layer or coating configured enhance connectivity (i.e., wifi, cellular) in residential and/or commercial applications.

### BACKGROUND OF THE INVENTION

A common building material in many residential and/or commercial applications is a wood panel product, or an integral composite engineered panel product, including, but not limited to, engineered wood composite products formed of lignocellulosic strands or wafers (sometimes referred to as oriented-strand board, or OSB). Products such as fiberboard and particleboard have been found to be acceptable alternatives in most cases to natural wood paneling, sheathing and decking lumber. Fiberboard and particleboard are produced from wood particles bonded together by an adhesive, the adhesive being selected according to the intended use of and the properties desired for the lumber. Often times, the adhesive is combined with other additives to impart additional properties to the lumber. Additives can include, but are not limited to, fire retardants, insect repellants, moisture resistant substances, fungicides and fungal resistant substances, and color dyes. A significant advantage of fiberboard and particleboard lumber products is that they have many of the properties of plywood, but can be made from lower grade wood species and waste from other wood product production, and can be formed into lumber in lengths and widths independent of size of the harvested timber.

A major reason for increased presence in the marketplace of the above-described product alternatives to natural solid wood lumber is that these materials exhibit properties like those of the equivalent natural solid wood lumber, especially, the properties of retaining strength, durability, stability and finish under exposure to expected environmental and use conditions. A class of alternative products are multilayer oriented wood strand particleboards, particularly those with a layer-to-layer oriented strand pattern, such as OSB. Oriented, multilayer wood strand boards are composed of several layers of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in U.S. Pat. Nos. 3,164,511, 4,364,984, 5,435,976, 5,470,631, 5,525,394, 5,718,786, and 6,461,743, all of which are incorporated herein in their entireties by specific reference for all purposes.

### SUMMARY OF INVENTION

In various exemplary embodiments, the present invention comprises an engineered wood substrate (such as, but not limited to, oriented-strand board, or OSB), with a connectivity layer configured to reflect radio frequency (RF) signals (e.g., wifi and/or cellular signals), thereby enhancing connectivity. The connectivity layer may be metallic, such as aluminum or copper. The layer may be a sheet or film of the metallic material applied to the surface or integrated into the interior of the panel, or may be a coating or deposited layer. The panel may be of any shape or size. The panel may be an external or internal component of the structure, such as an exterior sheathing panel for a wall or roof, or an internal wall, roof, or sub-flooring panel for a room or space.

In one exemplary embodiment, the panel is used as sub-flooring for a room. The sides and roof of the room are open to transmission of the RF signals, but are reflected by the sub-flooring connectivity panels to enhance the strength of the signals in the room, while preventing transmission or leakage of RF signals through the floor. In the event a room or space is sought to be protected from RF signals being transmitted therein (i.e., a “dead room), the connectivity panels may be used to prevent RF signals from passing therethrough. A wifi signal could still be received therein through a wired cable modem or router, or similar means. Such a signal would be free from RF interference from sources outside the room.

The energy attenuation can be further improved by using an embossed or patterned surface on the metallic foil or layer, thereby diffusively reflecting or scattering the energy rather than simple specular reflection of the energy. Diffusive reflection is the reflection of the signal from a surface such that the incident ray is reflected at many angles, rather than just at one angle as in the case of specular reflection. This better fills in the radiation nulls, thereby increasing the reliability of wireless networks within the home and avoiding the signal cancellation cause by certain reflected energy/signals interacting with core signals originating from a signal emitter or generator inside the structure, such as a router.

### BRIEF DESCRIPTION OF THE DRAWINGS

FIG. 1 shows a cross section of an engineered wood product with a single core layer and a single connectivity layer.

FIG. 2 shows a cross section of an engineered wood product with a single core layer and a connectivity layer on both faces of the core layer.

FIG. 3 shows a cross section of an engineered wood product with a single core layer and a connectivity layer integrated within the core layer.

FIG. 4 shows a cross section of an engineered wood product with a single core layer and a connectivity layer integrated within the core layer, and a connectivity layer on both faces of the core layer.

FIG. 5 shows a cross-section of an engineered wood product with a connectivity layer sandwiched between two engineered wood layers, with one of said engineered wood layers having another connectivity layer on a second face.

FIG. 6 shows a cross-section of the engineered wood product of FIG. 5, with one engineered wood layer a multi-layer composite.

FIG. 7 shows a cross section of an engineered wood product with a single core layer and a connectivity layer on both faces of the core layer, with the connectivity layer on the interior face comprising an embossed or patterned surface.

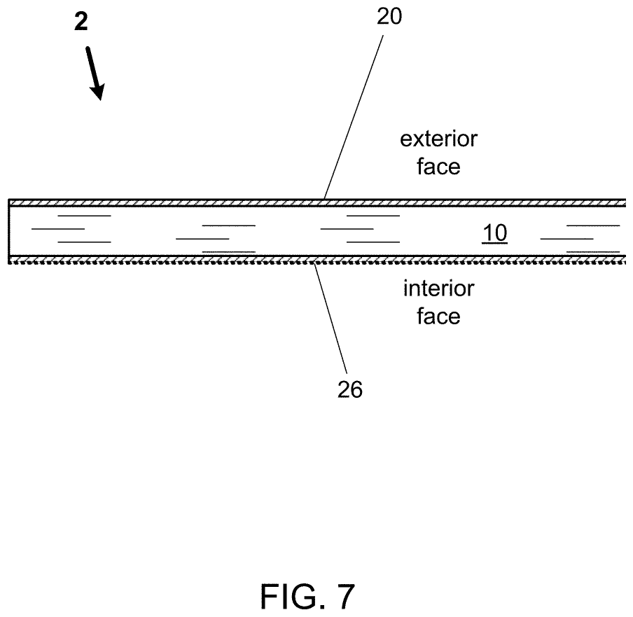

FIG. 8 shows a diagram of a structure with connectivity products in use.

### DETAILED DESCRIPTION OF EXEMPLARY EMBODIMENTS

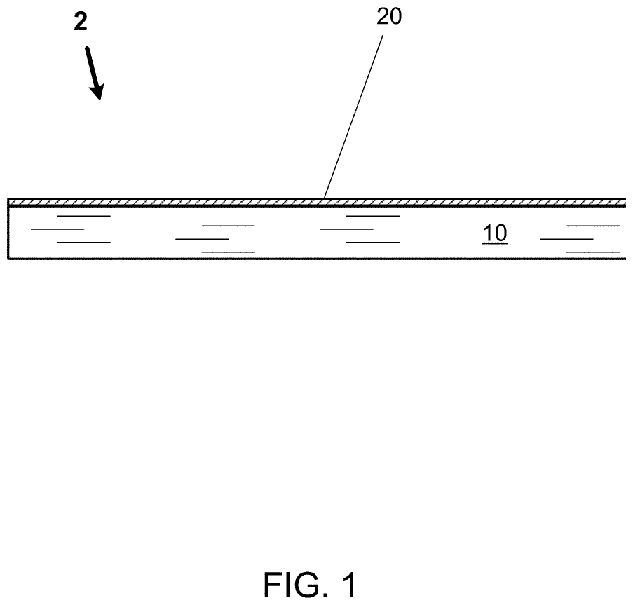

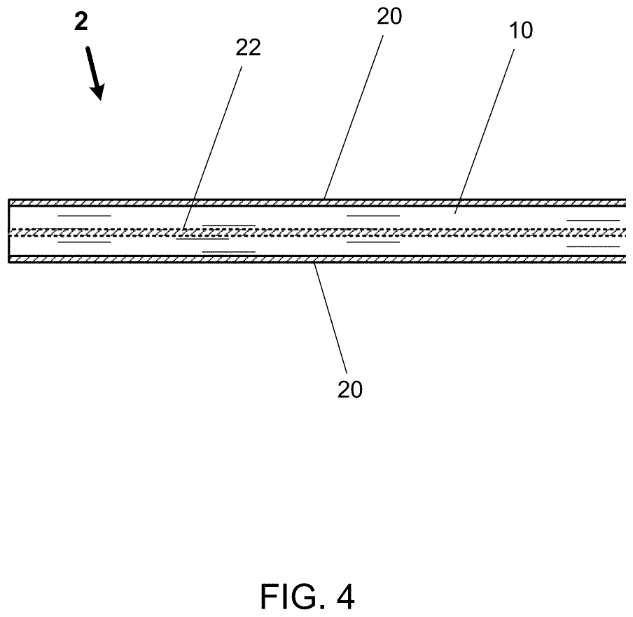

In various exemplary embodiments, as seen in FIGS. 1-4, the present invention comprises an engineered wood product 2 with at least one engineered-wood substrate or base (or core) layer 10 (such as, but not limited to, OSB), with a connectivity layer 20 configured to reflect RF signals (e.g., wifi and/or cellular signals) on one or more faces of the substrate or base/core layer, or integrated therein, thereby enhancing connectivity in adjacent or proximate spaces or areas.

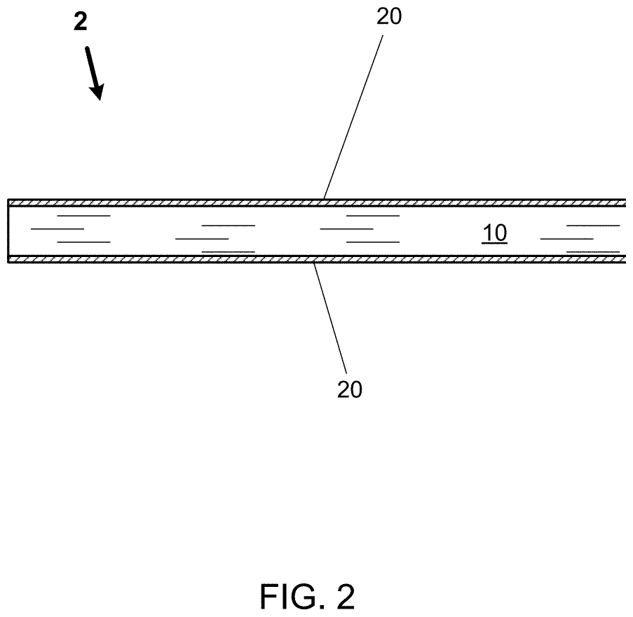

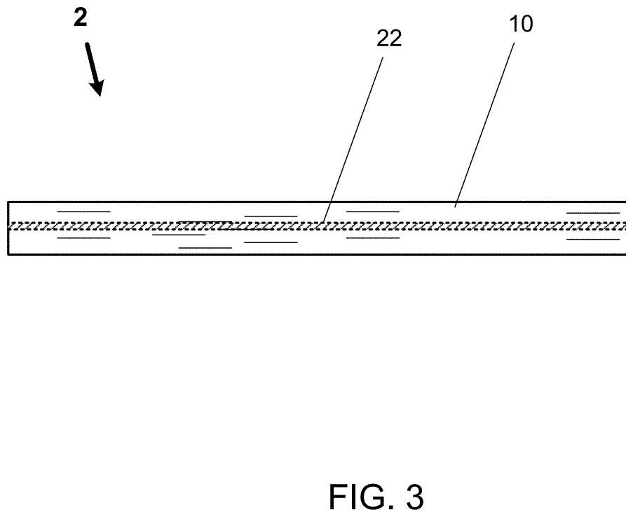

The connectivity layer 20 may be a metallic material, such as, but not limited to, aluminum or copper. The layer 20 may be a sheet or film or foil of the metallic material applied to the surface(s), as seen in FIG. 2, or integrated 22 into the interior, as seen in FIG. 3, of the substrate or core layer. The layer 20 also may be a coating or deposited layer.

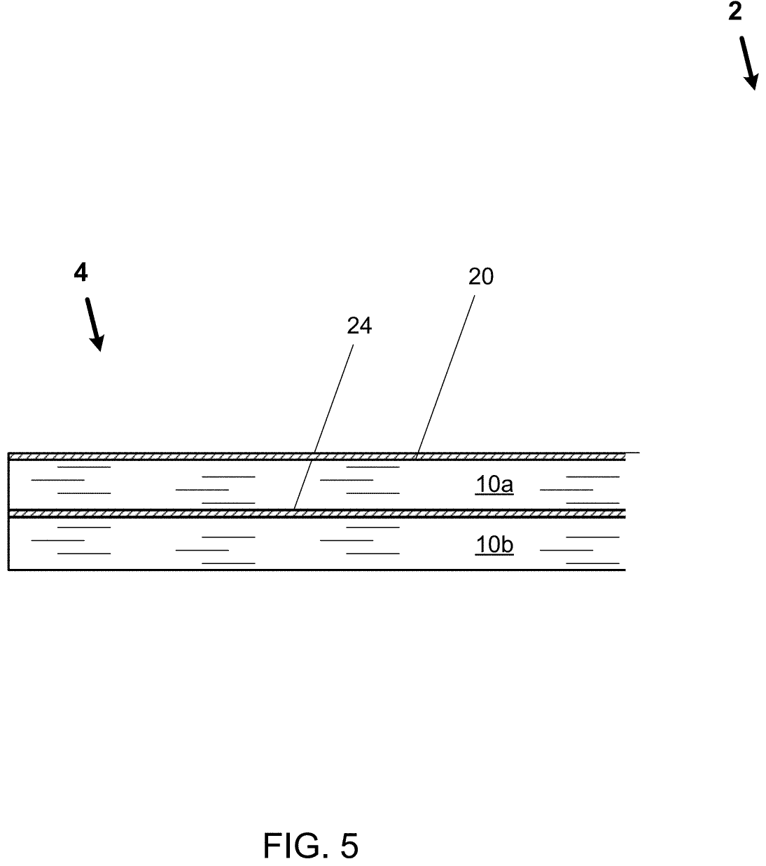

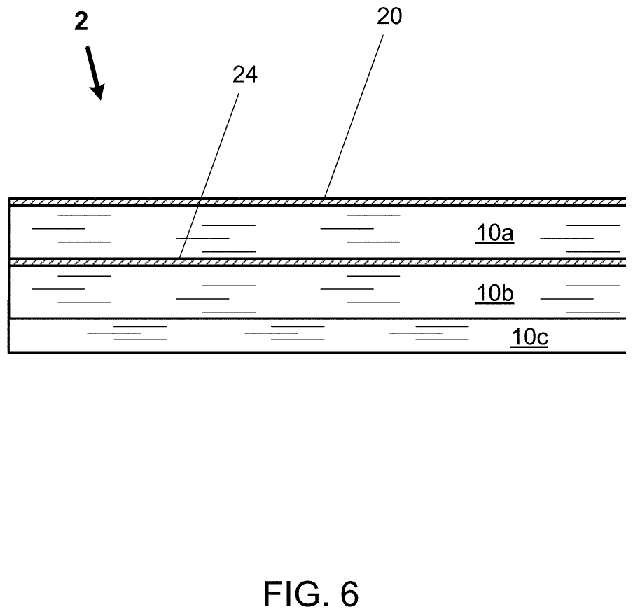

As seen in FIGS. 5 and 6, a connectivity layer 24 may be “sandwiched” between two or more engineered-wood substrates 10a, b forming a composite panel or product 4. Connectivity layers 20 may be placed on the outer surfaces of the composite product.

The substrate may be of any shape or size, and the product may comprise a panel, structural panel, board, flooring, roofing, plank, piece of siding, or other similar construction component. The connectivity product 2, 4 may be an external or internal component of a structure, such as an exterior sheathing panel for a wall or roof, or an internal wall, roof, or sub-flooring panel for a room or space.

In one exemplary embodiment, the connectivity product 2, 4 is a panel used as sub-flooring for a room. The sides and roof of the room are open to transmission of the RF signals, but are reflected by the sub-flooring connectivity panels to enhance the strength of the signals in the room, while preventing transmission or leakage of RF signals through the floor.

In another exemplary embodiment, the connectivity product is used as wall panels for an interior space within a structure, and/or structural panels on the exterior of the structure, with or without connectivity products used as sub-flooring panels.

In the event a room or space is sought to be protected from RF signals being transmitted into that room or space (i.e., a “dead room”), the connectivity product may be used on all sides, ceiling/roof, and sub-flooring to prevent RF signals from passing therethrough. A wifi signal could still be received therein or transmitted therein through a wired cable modem or router, or similar means. Such a signal inside the space would be free from RF interference from sources outside 110 the space. The space may comprise a room, part of a room, several rooms, an entire floor/story of a structure (for multi-story structures), or the entire structure or building.

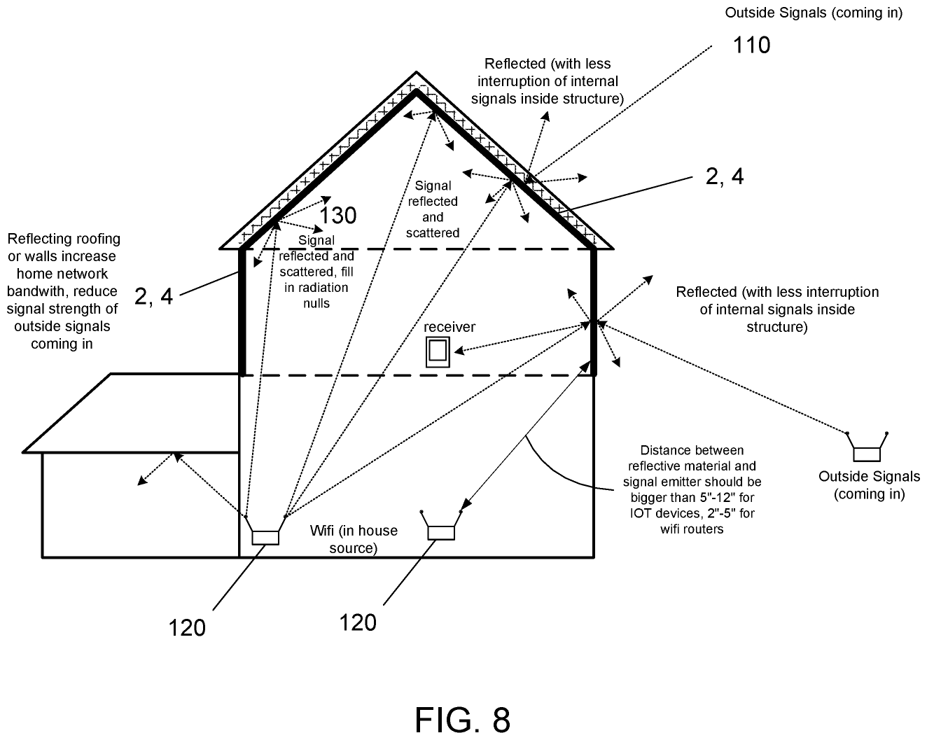

The energy attenuation can be further improved by using an embossed or patterned surface 26 on the metallic foil or layer, thereby diffusively reflecting or scattering the RF energy rather than simple specular reflection of the energy. Diffusive reflection is the reflection of the signal from a surface such that the incident ray is reflected at many angles, rather than just at one angle as in the case of specular reflection. As seen in FIG. 8, placing this embossed or patterned surface on the interior face of the product better fills in the radiation nulls in the room or space 130, thereby increasing the reliability of wireless networks within the home or structure and avoiding the signal cancellation cause by certain reflected energy/signals interacting with core signals originating from a signal emitter or generator 120 inside the structure, such as a router.

Example 1: An engineered wood product comprising OSB with metallic was constructed and tested using the Anechoic chamber test method, using test antenna 700 MHz-5.8 GHz frequency range, which covers 90% or more of all the market. At 2100 MHz, with no materials, the energy gain is +5 dB; with standard OSB without the metallic foil layer, the energy gain is +4 dB (i.e., energy loss of 1 dB from baseline); with the invention (OSB with metallic foil), the energy attenuation is 17 db, i.e., 98% of the energy is reflected.

Consumers expect reliable wireless performance in the home, and they do so at greater and greater ranges with the latest IoT devices and radio technologies. This biggest issue here is not the maximum range a wireless network can establish, but all the variables of building materials and structural layouts of the home causing wide swings in signal strength at different areas of the home causing unreliable communications. RF waves propagate easily in open spaces, free of absorptive or reflective materials which can create loss and shadowing. With indoor environments, wireless communications are rarely line-of-sight (los) and there is fading loss due to the high reflection environment and people moving within that environment. Thus, the smart home radio access technology must be able to handle a modest amount of fading. Z-Wave, Wi-Fi and newer technologies like LoRa do a fantastic job at this at modest ranges due to the inherent link margin built into the wireless system with typical use cases. Link margin is the ability for the wireless system to handle wide ranges in received power without loss of packets. For example, when your cellular phone has five bars of signal strength, it really means the phone has about 30 dB of link margin (dB is log, so 10 dB is 10×, 20 dB is 100×, 30 dB is 1000×), with 1 bar having only ˜6 dB of link margin. Generally, a link margin of 30 dB results in 99.9% reliability in a typical wireless system, as the signal level needs to drop 1000× for the receiver to lose information.

Link margin is governed by the signal bandwidth, quality of the receiver, nearby noise, antenna gain of the transmitter/receiver, signal frequency used, distance between antennas and conductors/absorbers between the antennas. All else being equal, the higher the bandwidth, the poorer the receiver sensitivity and lower the overall range. Higher transmit power means more range (as long as both links are higher power). For line-of-sight systems, the higher antenna gain (focused energy in one direction or plane), the more range. Note, antenna gain only helps if you know where the receiver is; otherwise focusing the energy may reduce the reliability of the system.

Free space path loss quadruples for a doubling of the distance between transmitter and receiver or a doubling of the signal frequency. Thus, the shorter distance or lower frequency used, the more link margin the system will have. However, path loss in a home is much more heavily influenced by the physical locations/orientations of the transmitter/receiver, the layout of the home and the building materials used. For example, the in-home path loss may be closer to 10× for a doubling of the distance between router and device. Generally, the lower the frequency of the signal, the more likely it will penetrate through building materials, as the loss from these materials is greater at higher frequencies. Thus, the 900 MHz ISM band will inherently have more indoor range than the 2.4 GHz ISM band, which in turn will have more indoor range than the 5 GHz ISM band and 5G mm wave (north of 6 GHz) having practically no indoor use due to the loss in the building materials. As far as frequency use versus wireless range goes, the same can be said for outdoor communication systems, yet here it is easier to achieve a physically larger, higher gain antenna to help focus the energy and close the wireless link at higher frequencies and long distances (e.g., satellite TV).

The most robust indoor wireless network will have a very large link margin. Link margin is the amount of additional loss the link can handle without losing information (e.g., packet loss). More indoor link margin can be obtained by using lower frequencies (less loss in materials), higher TX power (governed by FCC and other regulatory bodies) and lower signal bandwidths/data rates (some radio technologies are built for high data like Wi-Fi; some are built for low data rates like Z-Wave or LoRa) and placing the transmitter and receiver closer to each other. Open floor plans (fewer building materials) will greatly help with link margin. Also, not having to compete with nearby networks (neighbor's high power Wi-Fi) or external noise will improve link margin and allow higher data rates.

Introducing absorbers or conductors between the transmitter and receiver of any wireless network will likely only reduce link margin; therefore, reducing the reliability and range of the wireless system. Having said that, by placing conductive material (reflectors) on the outside of the intended network coverage area, one could help fill in radiation nulls and improve the reliability of an indoor or other non-line-of-sight (LOS) wireless network. However, the same reflectors will reduce signal strengths of outside signals coming in or going out from the home as well. This could be useful in blocking a neighbor's Wi-Fi signals and hence increasing the home's network bandwidth, yet at the same time will reduce cellular signal strength in the home, potentially reducing cellular quality of service and even causing dropped calls. The quality of service of the cellular network will be heavily dependent on the location of nearby cellular towers, and hence some homes could withstand large losses in signal strength and have no adverse effects on their cellular phone service, whilst others, particularly in rural environments with no nearby towers, could have very poor quality of service due to any additional reflectors in the home.

Wi-Fi interference coming from nearby networks is one cause of poor Wi-Fi throughput (download/upload speeds). Wi-Fi (like cellular) systems adjust the signal modulation/data rate as the signal-to-noise (SNR) ratio improves. Thus, if a signal is very strong and noise is weak, a deep modulation scheme will be used with data rates in the 10s of Mbps or even Gbps. However, when there is in-band noise (e.g., neighbor is using the same Wi-Fi channel or nearby channel), the denominator of the SNR increases reducing the SNR. With a reduced SNR, the Wi-Fi radio will adjust the modulation used to keep a minimal packet reliability. Worst case, it could use 802.11b modulation with data rates as low as 1 Mbps. Also, if the neighbor is using channel 1 and so is your access point, you'll be forced to time division the channel (meaning you cannot upload/download at the same time as the neighbor), greatly reducing the average throughput of your access point. This means a movie download could take 10 min with a lot of background noise and 10s with no noise. With the use of 5 GHz (802.11g/ac) and 6 GHz (802.11ax) Wi-Fi, the density problem fades away. This is due to the much larger free space path losses and building material losses at higher frequencies, so your access point doesn't ‘see’ the other 5 GHz/6 GHz access points. Knowing the RF properties of building materials is, in-itself a good marketing tool, as many manufacturers won't have this information, and is very useful in determining how a wireless network will perform in the home. Having material options with conductive properties gives the customer more freedom in customizing how smart devices will perform in the home.

Water is resonant within the ISM frequency bands (900 MHz, 2.4 GHz, 5 GHz) absorbing a lot of energy, thus anything one can do to minimize water absorption in the building materials will improve RF propagation and hence increase wireless range and link reliability in the home. Of course, open floor plans are the best path here: removing the building materials altogether to facilitate RF propagation from room to room.

Strategically placing conductive materials in the corners of the house will help reflect signals back into the house whilst slightly reducing the amount of RF energy coming from the neighbor's house and potentially other external noise. The wall/corner reflector will effectively reduce the Wi-Fi range outside the home and help with privacy/security. The only issue is that it is difficult to suppress Wi-Fi signals and pass cellular signals due to the proximity in signal frequency (cellular in the US uses 600 MHz-900 MHz, 1700 MHz-2200 MHz and 2500-2700 MHz while Wi-Fi uses 2400-2480 MHz and 5000-5850 MHz).

There are ways to filter Wi-Fi and pass cellular signals, yet it is a topic of a PhD thesis or other extended research study. The basic premise is to use narrowband filters by way of fine electrical structures etched on polyimide or printed with silver ink on large sheets. The structures would attenuate 2.4 GHz Wi-Fi and pass other frequencies. The 5 GHz Wi-Fi band has a lot more bandwidth (˜800 MHz vs ˜80 MHz) and filtering out this band would be much more difficult. Yet, filtering 5 GHz is much less of an issue to the higher frequency used which has much more free space path loss and loss in building materials.

The largest benefit of the corner reflector is the scattering it will create, which will likely fill in radiation nulls within the home. No antenna is isotropic, and thus will have nulls where the radiation from the antenna is very weak. These nulls can be filled in with scattering from reflectors.

In another embodiment, thin strips of conducting material may be used to help create reflections and polarization changes. In one example, 1″ wide conductive strips are used throughout the walls, and these would be spaced about by 12-24″. This may help with Wi-Fi MIMO (multiple-in multiple-out) throughput as each Wi-Fi antenna would see a different polarization. Wi-Fi routers typically use two to six antennas to assist with multi-band and MIMO support, allowing for a more reliable connection, better SNR and higher data throughput.

Placing conductive materials in the subfloor of the home will help reflect signals back into the first and second floors, yet greatly hamper signals to and from the basement, if present. This could degrade the performance of security systems, Wi-Fi, BLE and cellular phones that located in the basement. If the home does not have a basement, the conductive subfloor becomes much more viable. The ground (earth's crust) is both reflective and absorptive. Soil is more absorptive at ISM frequencies. Concrete or asphalt is more reflective and here there will be less of an impact with a conductive subfloor. Yet, this really depends on the conductivity of the building material in question. If it is very conductive material (e.g., metal sheet or tape), the reflected energy will be much greater a reflection from the earth would be.

Placing conductive materials in the roof of the house will help reflect signals back into the second and first floors and fill in null areas of the home for ISM frequencies. With a reflective roof, one can keep more of the RE energy in the house versus dissipating it in the trusses, insulation and shingles (or other roofing material). This could very well have a positive effect on wireless networks in the home. The risk with a conductive roofing material is if a router is placed near the ceiling, in which case the close proximity from the reflector to the router could exacerbate multi-path fading causing weaker signal at the router. For example, if the Wi-Fi router is within a few inches of the reflective material, it could effectively focus the energy and create more null zones in the radiated energy. Nowadays routers have multiple antennas, and the risk of having nulls in the radiation pattern (even with nearby large reflectors) is greatly diminished. Multiple antennas gives polarization diversity (i.e., which way the electric field is oriented: horizontal or vertical) and spatial diversity (antennas are separated by a fraction of a wavelength) and these greatly increase the probability of receiving a reliable signal in a high reflection environment like a home.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. An engineered-wood product with enhanced connectivity, comprising:
a base layer of engineered wood; and
a metallic connectivity layer configured to reflect radio-frequency signals attached or integrated with the core layer.

2. The product of claim 1, wherein the base layer has a first face and a second face, and the metal connectivity layer is affixed to the first face.

3. The product of claim 2, further comprising a second connectivity layer affixed to the second face.

4. The product of claim 1, wherein the metallic connectivity layer comprises a metallic foil.

5. The product of claim 1, wherein the metallic connectivity layer comprises a metallic sheet.

6. The product of claim 1, wherein the metallic connectivity layer comprises a metallic film.

7. The product of claim 1, wherein the base layer has a first face and a second face and an interior therebetween, and the metallic connectivity layer is integrated into the interior of the base layer between the first face and second face.

8. The product of claim 1, further comprising a second base layer of engineered-wood, wherein the metallic connectivity layer is positioned between the base layer and the second base layer.

9. The product of claim 1, wherein a face of the metallic connectivity layer is embossed or patterned and configured to diffusively reflect the radio-frequency signals.

10. The product of claim 1, wherein the metallic connectivity layer comprises aluminum or copper.

11. The product of claim 1, wherein the product is an oriented-strand board panel.

12. The product of claim 11, wherein the product is a structural panel.

13. The product of claim 1, wherein the product is an exterior sheathing panel, an internal wall panel, a roofing panel, or a sub-flooring panel.

14. The product of claim 1, wherein the product is configured to diffusively reflect the radio-frequency signals back into a space containing the source of the radio-frequency signal while preventing transmission of radio-frequency signal from outside the space.
